(19) United States
(12) Patent Application Publication
(10) Pub. No.: US 2010/0288365 A1
(43) Pub. Date: Nov. 18, 2010

(54) SANITARY DUAL-HANDLED FAUCET HANDLE ASSEMBLY

(76) Inventor: Terry McEnaney, Lovettsville, VA (US)

Correspondence Address: Ian Coyle, 13193 Mountain Road, Lovettsville, VA, 20180, US

(21) Appl. No.: 12/782,670

(22) Filed: May 18, 2010

Related U.S. Application Data
(60) Provisional application No. 61/216,391, filed on May 18, 2009.

(51) Int. Cl. F16K 31/60; E03C 1/04

(52) U.S. Cl. 137/1; 137/315.15; 137/801

(57) ABSTRACT

A faucet handle assembly comprising two distinct handles is described, and a sanitary method for operating the handle assembly is provided. One handle is attached near the distal end of a stem and the other handle is attached at an intermediate position between the first handle and the proximal end of the stem. The proximal end of the stem is operably coupled to a valve such that movement of either handle causes corresponding movement of the stem which then actuates the valve. One handle may be designated for operation by clean or sanitized hands only, while the other handle may be designated for operation by dirty or unsanitized hands only. Sanitary use of the faucet is achieved by turning a valve on with the latter handle and off with the former handle.

### CROSS-REFERENCE TO RELATED APPLICATIONS

This application claims priority from U.S. Provisional Patent Application No. 61/216,391, filed May 18, 2009, which is incorporated by reference herein.

### BACKGROUND

1. Field of the Invention

The field of the present invention relates to faucet handle assemblies in which a handle, knob, or other graspable element is attached to a stem, and said stem is operably coupled to a valve in the faucet, such that movement applied to the handle is transferred via the stem to the valve or an intermediate coupling, thereby actuating said valve. More particularly, the present invention describes a faucet handle assembly wherein two handles are attached to a stem that is operably coupled at its proximal end to a valve of a faucet, one of said two handles being located distal to the other of the said two handles on the stem. The two handles actuate the same valve via a common stem, but each of the handles has a distinct utility. One handle is designated for contact with unclean or unsanitized hands and objects, while the other handle is designated for contact with clean or sanitized hands and objects, thus enabling a more sanitary method of operating a faucet.

2. Background of the Related Art

Faucet handle assemblies in the prior art typically comprise a single handle or knob operably linked to a valve by a stem or shaft. Rotating the handle or knob turns the stem or shaft about its axis and thereby actuates the valve. For example, the invention disclosed in U.S. Pat. No. 7,540,300 to Thomas et al., issued Jun. 2, 2009, entitled “Faucet Handle Mounting” describes a single-handled faucet handle assembly and is incorporated by reference herein. Similarly, U.S. Pat. No. 7,624,757 to Schmitt issued Dec. 1, 2009, entitled “Dual Function Handles for a Faucet Assembly,” which is incorporated by reference herein, describes a single-handled faucet handle assembly that actuates a valve either directly by mechanical force or indirectly through an electric motor. The portion of the faucet control mechanism that comprises the handle, knob, or other means for manipulation together with its attached stem, shaft, or other axial member can be referred to as a “handle assembly.”

Water-dispensing faucets of the types commonly installed at sinks, washtubs, showers, and other fixtures generally incorporate two user-controlled valves, one for hot water and one for cold water, wherein each valve is coupled to a solitary handle on a faucet handle assembly. In the prior art, the handle is usually mounted on the distal end of the stem, while the proximal end of the stem engages the valve, such that torque is translated from the handle to the valve by rotation of the stem. In many instances, the stem of the handle assembly is indirectly coupled to the valve via an intermediate apparatus such as a motor, lever, gear, or other coupling means.

An alternative arrangement of prior art faucet assemblies commonly observed in showers and kitchen sinks comprises a single-handled faucet handle assembly coupled to a mixing valve, through which both the hot and the cold water flow. Operation of the handle modulates the internal settings of the mixing valve to determine the proportions of hot and cold water flowing through the faucet at any point in time. The handle assembly controlling the mixing valve typically comprises a handle that resembles a lever, which may move side-to-side or up-and-down, or it may comprise a knob that rotates on an axial stem. Two examples of lever-operated mixing valves are described in U.S. Pat. No. 4,730,640 to Moen, issued Mar. 15, 1988, entitled “Handle Construction for Mixing Valve,” which is incorporated by reference herein, and in U.S. Pat. No. 5,608,928 to Wang, issued Mar. 11, 1997, entitled “Faucet of a Sink,” which is incorporated by reference herein.

Faucets like those of the prior art described above which incorporate handle assemblies that comprise only one actual handle are an inconvenience and a health hazard, because a user must touch that handle in order to turn on the corresponding valve before his or her hands have been cleaned or sanitized in the faucet. Then, when turning off that valve after the user's hands have been cleaned or sanitized, the same dirty or unsanitary handle must be touched again. This creates an opportunity for germs, grime, or other filth to collect on the handle and to then to re-contaminate the user's hands after washing.

### SUMMARY OF THE INVENTION

The present invention sets forth an improved, more sanitary, faucet handle assembly comprising two handles attached to a single stem or shaft. One handle is positioned at or near the distal end of the stem, while the other handle is positioned more proximally at an intermediate position on the stem, while the proximal end of the stem engages a valve, either directly or indirectly. Some examples of handle assemblies that indirectly engage valves are those which first connect to a motor, electronic actuator, or gearbox which then sends positional information to the valve assembly. Whether directly or indirectly engaged by the handle assembly of the present invention, the engaged valve may be a standard fluid valve, a mixing valve that interpolates two or more fluid inputs, or any other type of valve useful for controlling fluid flow through a faucet.

One of the two handles of the present invention, typically the distal handle, is maintained in a clean or sanitized condition while the other of the two handles, typically the proximal handle, is allowed to remain relatively dirty or unsanitized. A person using the faucet may first contact the proximal handle, manipulating it to open, or “turn on,” the associated valve. Then, after washing or sanitizing the hands or other objects or anatomy under the faucet, the person may close the valve, or “turn off” the valve, using the distal handle. The present invention may be utilized to control each of the valves in any faucet, i.e., such that both the hot and cold water valves are actuated by distinct dual-handled faucet handle assemblies, or, such that a single mixing valve is controlled by one dual-handled faucet handle assembly.

### BRIEF DESCRIPTION OF THE DRAWINGS

FIG. 1 is a perspective view of a first embodiment of the dual-handled faucet handle assembly of the present invention, showing it attached to one valve of a faucet.

FIG. 2 is a perspective view of a second embodiment of the dual-handled faucet handle assembly of the present invention depicting two handles of differing shapes attached to the stem.

FIG. 3 is a perspective view of a third embodiment of the present invention utilized in a faucet that comprises a mixing valve instead of separate valves for hot and cold water.

### DETAILED DESCRIPTION

Throughout all the Figures, same or corresponding elements are indicated by the same reference numerals.

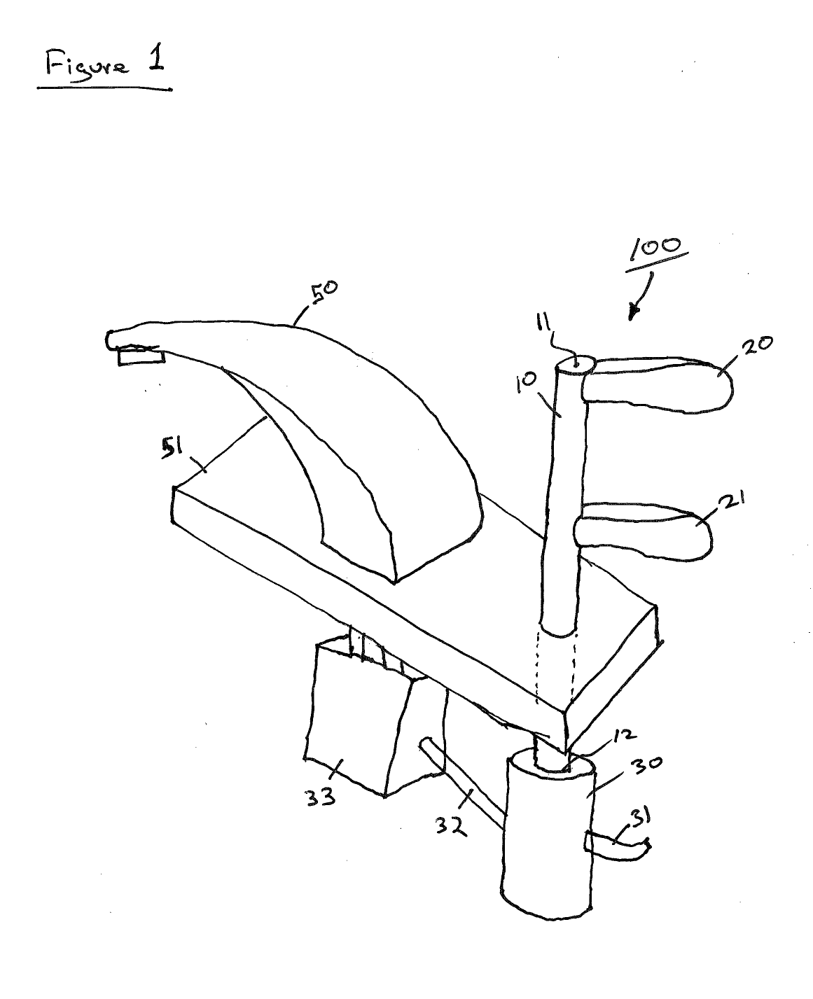

FIG. 1 is a perspective view of the preferred embodiment of the dual-handled faucet handle assembly 100 of the present invention. A standard faucet 50 is depicted mounted upon an escutcheon 51 near any sink, basin, tub, or other washing area. The handle assembly 100 is operably linked to a valve 30 associated with the faucet 50. The proximal end 12 of the stem 10 is coupled directly to the valve 30. In other embodiments the proximal end 12 of the stem 10 may be coupled indirectly to the valve 30 via an intervening motor, power control, gear, or other means for translating handle rotation into valve actuation. When the valve is open, fluid enters through the input line 31 and travels towards the faucet via the output line 32. A mixer 33 or other intervening apparatus may collect fluid from one or a plurality of valves before distributing fluid to the faucet.

Both handles 20 and 21 in the preferred embodiment protrude laterally from the stem 10 at identical angles from the central axis 11 of the stem. However, each of the two handles 20 and 21 occupies a different longitudinal position on the stem 10. Throughout this specification, these may be referred to as the “upper” or “top” position and the “lower” or “bottom” position, or, they may be referred to as the first and second positions without regard to which is the upper or lower handle. Similarly, the two handles may be described as occupying “one position” and “the other position,” also without regard to which of them is above or below the other. The handles 20 and 21 in FIG. 1 are attached to the stem 10 by welding, but in other embodiments the handles may be attached by screws, bolts or any other fastening means, or, the handles and the stem may be formed together from a single piece of metal, plastic, or other material.

When a user prepares to operate the faucet 50, the valve 30 is opened by rotating either of the two handles, 20 and 21, so that the stem 10 rotates on its central axis 11. Said rotation causes the valve 30 to open, permitting fluid to flow in through the intake line 31 and out through and output line 32 to the faucet 50. A second valve, not shown, may be opened by repeating this motion on another handle assembly coupled to the second valve.

After the desired volume of water or other fluid is flowing out of the faucet 50, the user may wash, rinse, or sanitize his or her hands or other items or anatomy under the stream. Subsequently, the user may close the valve 30 by rotating either of the two handles 20 or 21 so that the stem 10 rotates in the direction opposite that which previously opened the valve 30. If necessary, a second valve may be closed using the corresponding motion on a second handle assembly.

Having two handles instead of one, the handle assembly of the present invention permits a more sanitary method for opening and closing the valves of a faucet than previously permitted by the prior art. When one handle is designated as the “dirty” handle, a user with unsanitized hands may resort to this handle when turning on a valve in the faucet. After washing or sanitizing his or her hands or other objects in the faucet, the user may then turn off the valve using the other, or “clean,” handle. This way, filth that accumulates on the primary handle does not transfer back to the user's clean hands after washing.

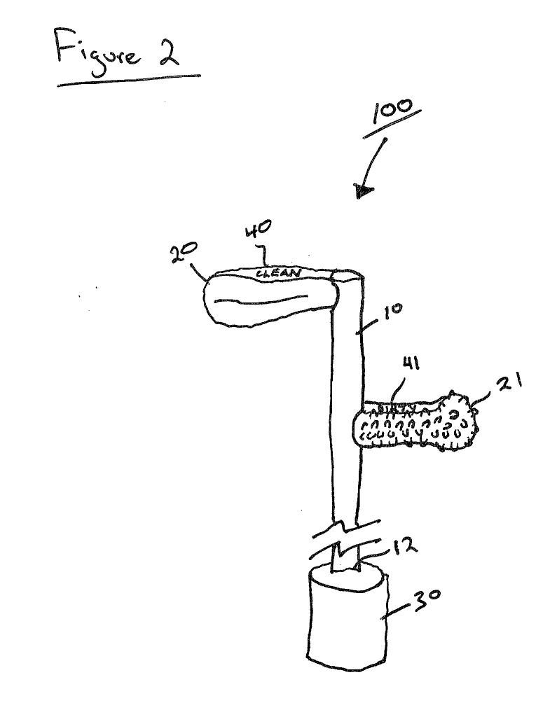

Each of the two handles 20 and 21 may bear labels, lettering, or other indicia to indicate their respective purposes to the user. In FIG. 2, the top handle 20 has text 40 embossed or carved in its upper surface spelling “clean” to signify that only clean hands should touch this handle. The bottom handle 21 may incorporate counterpart text 41 spelling “dirty” to indicate that only dirty or unsanitized hands should touch this handle. In such an arrangement, a person would use the handle 21 labeled “dirty” 41 to open the corresponding valve 30 and then would use the other handle 20, labeled “clean” 40, to close the same valve 30. Other appropriate text or characters may be substituted for “clean” and “dirty”, such as “off” and “on,” respectively.

An alternative way to distinguish between the two handles is to fashion the upper and lower handles differently from each other, for example using different materials or having different shapes. The invention contemplates design modifications wherein the shape of each handle suggests its function to the user. For example, FIG. 2 depicts a rough-textured or studded handle 21, which may suggest dirtiness to the user, while the polished or smooth handle, 20, suggests cleanliness.

In the preferred embodiment of FIG. 1, the two handles 20 and 21 protrude laterally from the stem 10 with one handle 20 placed higher on the stem than the other handle 21, the handles being located along the stem 10 some distance apart such that users have the ability to manipulate the lower handle 21 without touching the upper handle 20, and vice versa. However, the invention contemplates variations in which the two handles extend from the stem at different angles, such as the two handles 20 and 21 in FIG. 2. Here, the upper handle 20 extends from the left side of the stem while the lower handle 21 extends 180 degrees in the opposite direction, and they both control the valve 30 coupled to the proximal end 12 of the stem.

In the preferred method of use, the upper handle of the present invention is the “clean” or “off” handle while the lower handle is the “dirty” or “on” handle. This arrangement is preferable because grime, dirt, or liquid from the upper handle may drip, run, or fall downwards upon the lower handle. The lower handle is thus more conveniently designated as the less sanitary of the two. However, some embodiments may reverse this arrangement for various reasons. One reason why the bottom handle may be designated the “clean” or “on” handle is so that children, a wheelchair bound person, or other person who may not wish to ever come into contact with the “dirty” handle may have easier access to the “clean” handle at this lower position.

Throughout this specification, the word “handle” is used interchangeably with knob, lever, grip, or other synonyms of handle. In any case, the handle is a portion of the handle assembly that is intended to be grasped by the user when manipulating the assembly to actuate its corresponding valve. The word “stem” is synonymous with shaft, pin, rod, bar or other synonym of stem. The words “clean” and “sanitized” can mean sterile, or, merely clean but not sterile, or, merely washed but not clean, in addition to their customary synonyms. The words “dirty” or “unsanitized” can mean not yet sanitized, infected, soiled, wet, unwashed, unrinsed, or otherwise unclean in addition to their customary synonyms.

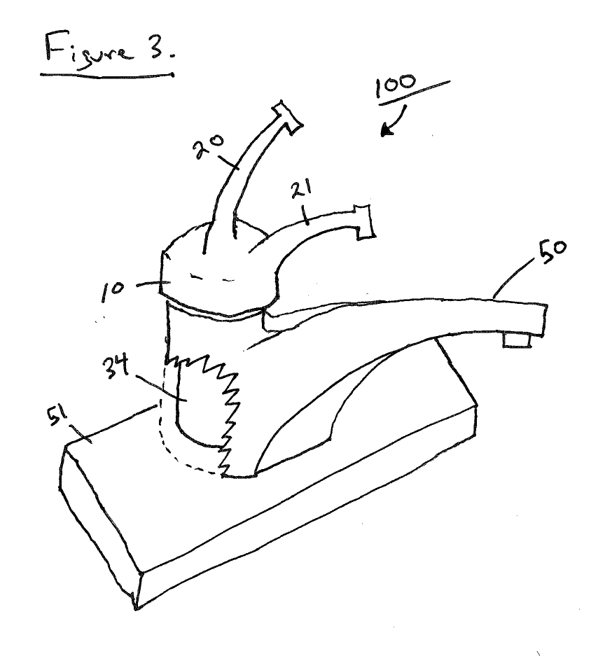

FIG. 3 depicts a third embodiment 100 of the dual-handled faucet handle assembly of the present invention, shown attached to a faucet 50 that employs a mixing valve 34 to simultaneously regulate the flow of hot and cold water. Instead of an obvious stem that rotates about a central axis, mixing valves often have a lever that moves laterally and horizontally to operate the valve. In such arrangements, the proximal portion of the lever which contacts the valve 34, or to an intervening coupling member, is considered equivalent to the stem 10 of the present invention, while the portions of the lever that are grasped by the user when controlling the valve 34 are considered equivalent to the handles, 20 and 21. As illustrated in FIG. 3, a dual-handled faucet handle assembly 100 of the present invention utilized with a mixing valve 34 may, in at least some embodiments, comprise handles 20 and 21 that resemble levers, but which do not move independently of each other.

It should be emphasized that the above described embodiments of the present invention exemplify some, but not all, possible implementations of the present invention and have been set forth in order to provide a clear understanding of its qualities. Variations and modifications may be made to the above-described embodiments of the dual-handle assembly of the present invention without departing from the spirit and principles of the invention. All such modifications and variations are intended to be included herein.

What I claim is:

1. A handle assembly for faucets, comprising:
A stem, having a proximal end and a distal end,
A first handle attached to the stem at or near the distal end,
A second handle attached to the stem at an intermediate position between the first handle and the proximal end of the stem,
Wherein the proximal end of the stem is operably coupled to a valve, such that movement of either the first handle or the second handle causes the stem to move, said movement being translated into valve actuation either within the valve or by an intervening coupling element.

2. The handle assembly of claim 1, wherein
The first handle is shaped, marked, assembled or composed differently from the second handle.

3. A sanitary method of actuating a valve comprising the steps of:
Providing a dual-handled faucet handle assembly comprising a stem having a proximal end operably coupled to the valve, a first handle attached at or near the distal end of the stem, and a second handle attached to said stem at an intermediate position;
Rotating the second handle to cause the opening of the valve; and
Rotating the first handle to cause the closing of the valve.
